(19) United States
(12) Patent Application Publication
(10) Pub. No.: US 2018/0072022 A1
(43) Pub. Date: Mar. 15, 2018

(54) CURVED STACK STRUCTURES, MANUFACTURING METHODS THEREOF AND CURVED ELECTRONIC DEVICES

(71) Applicant: InnoLux Corporation, Miao-Li County (TW)

(72) Inventors: Yi-Chun TSAI, Miao-Li County (TW); Ying-Yao TANG, Miao-Li County (TW); Tsu-Hsien KU, Miao-Li County (TW)

(21) Appl. No.: 15/685,161

(22) Filed: Aug. 24, 2017

Related U.S. Application Data
(60) Provisional application No. 62/394,269, filed on Sep. 14, 2016.

(30) Foreign Application Priority Data
Nov. 21, 2016 (CN) 201611024496.1

(51) Int. Cl. B32B 17/10; B32B 38/18; B32B 37/10; B32B 3/18; C09J 133/12; C09J 7/02; B29C 53/04; G02B 5/00

(52) U.S. Cl. CPC B32B 17/10009; B32B 38/1866; B32B 37/1018; G02B 5/003; C09J 133/12; C09J 7/0257; B29C 53/04; B32B 3/18

(57) ABSTRACT

A curved stack structure is provided. The curved stack structure includes a base having a curved surface. An adhesive layer is disposed on the base, and a substrate is disposed on the adhesive layer, wherein the substrate has a first thickness that is greater than or equal to 0.01 mm and less than or equal to 0.4 mm. A fabrication method of the curved stack structure and a curved electronic device including the curved stack structure are also provided.

### CROSS REFERENCE TO RELATED APPLICATIONS

This Application claims priority of U.S. Provisional Patent Application Ser. No. 62/394,269, filed on Sep. 14, 2016 and China Patent Application No. 201611024496.1, filed on Nov. 21, 2016, the entirety of which is incorporated by reference herein.

### BACKGROUND

### Field of the Invention

The disclosure relates to curved stack structures, and in particular to curved stack structures having thinner glass, manufacturing methods thereof, and curved electronic devices including the curved stack structures are applied.

### Description of the Related Art

Curved structures have been widely used in household appliances, communication devices, and electronic information devices. Currently, curved structures can be combined with a touch panel and a display panel to use as a touch display device, the touch display device allows users to directly select images shown on the panel using a finger or a touch pen. Therefore, touch display device can provide an efficient operation system, gradually replacing physical keyboards as the input interface of choice in various electronic products.

Methods for fabricating a curved glass having a decoration layer in a conventional curved structure generally include a printing process after a bending process. However, in the processes of printing after bending, since the curved glass has a complex appearance, the subsequent printing process (and other processing) is hard to perform. Therefore, conventional curved structures have the problem of having a lower quality of appearance uniformity. Thus, conventional curved structures still have a bottleneck to break through.

### BRIEF SUMMARY

In some embodiments of the disclosure, a curved stack structure is provided. The curved stack structure includes a base having a curved surface and an adhesive layer disposed on the base. The curved stack structure also includes a substrate disposed on the adhesive layer, wherein the substrate has a first thickness that is greater than or equal to 0.01 mm and less than or equal to 0.4 mm.

In some embodiments of the disclosure, a method for fabricating a curved stack structure is provided. The method provides a base having a curved surface and fabricating an adhesive layer on the base. The method also provides a substrate and attaches the substrate to the adhesive layer, wherein the substrate has a first thickness that is greater than or equal to 0.01 mm and less than or equal to 0.4 mm.

In some embodiments of the disclosure, a curved electronic device is provided. The curved electronic device includes a curved stack structure. The curved stack structure includes a base having a curved surface and an adhesive layer disposed on the base. The curved stack structure also includes a substrate disposed on the adhesive layer. The curved electronic device also includes a display panel disposed at a side of the curved stack structure, wherein the substrate has a first thickness that is greater than or equal to 0.01 mm and less than or equal to 0.4 mm.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIGS. 1A-1D shows perspective views of various stages of a method of fabricating a curved stack structure according to some embodiments of the disclosure.

FIGS. 2A-2D shows perspective views of various stages of a method of fabricating a curved stack structure according to some other embodiments of the disclosure.

FIGS. 3A-3D shows perspective views of various stages of a method of fabricating a curved touch panel according to some embodiments of the disclosure.

FIGS. 4A-4D shows perspective views of various stages of a method of fabricating a curved touch panel according to some other embodiments of the disclosure.

FIG. 5A shows a cross section of a curved electronic device according to some embodiments of the disclosure.

FIG. 5B shows a cross section of a curved electronic device according to some other embodiments of the disclosure.

FIG. 6 shows a cross section of a curved electronic device according to some other embodiments of the disclosure.

FIG. 7A shows a cross section of a curved electronic device according to some other embodiments of the disclosure.

FIG. 7B shows a cross section of a curved electronic device according to some other embodiments of the disclosure.

FIG. 8 shows a cross section of a curved electronic device according to some other embodiments of the disclosure.

### DETAILED DESCRIPTION OF THE INVENTION

The following description is about a curved stack structure, fabricating methods thereof and curved electronic devices including the curved stack structures are applied according to embodiments of the disclosure. However, it should be appreciated that the embodiments of the disclosure provide lots of suitable concepts of the invention and can be performed in a wide variety of specific backgrounds. The specific embodiments of the disclosure are used to explain the fabrication by specific methods and use of the invention and should not be taken in a limiting sense. The scope of the invention is best determined by reference to the appended claims. Moreover, the same or similar elements in the drawings and the description are labeled with the same reference numbers.

In the embodiments of the disclosure, a structure (a layer, an element, a substrate) located on another structure (a layer, an element, a substrate) can mean that two structures are adjacent to each other and directly connected with each other. It can also mean that the lower surface of one structure is adjacent to and directly connected with the upper surface of another structure, or it can also mean that two structures are adjacent to each other and not directly connected with each other. It can also mean that at least one interposed structure (an interposed layer, an interposed element, an interposed substrate, an interposed spacer) between two structures, and the lower surface of a structure is adjacent to or directly connected with the upper surface of the interposed structure, and the upper surface of another structure is adjacent to or directly connected with the lower surface of the interposed structure. The interposed structure can be made of a single layer or multiple layers of a physical structure or a non-physical structure, but the disclosure is not limited thereto.

The thickness of a structure described in the embodiments of the disclosure indicates a value for the average thickness of the structure after deleting outliers. The outliers can be the thickness of an edge, an obvious micro-trench, or an obvious micro-raised area. After deleting the outliers, most values of the thickness are within a range of plus or minus three standard deviations.

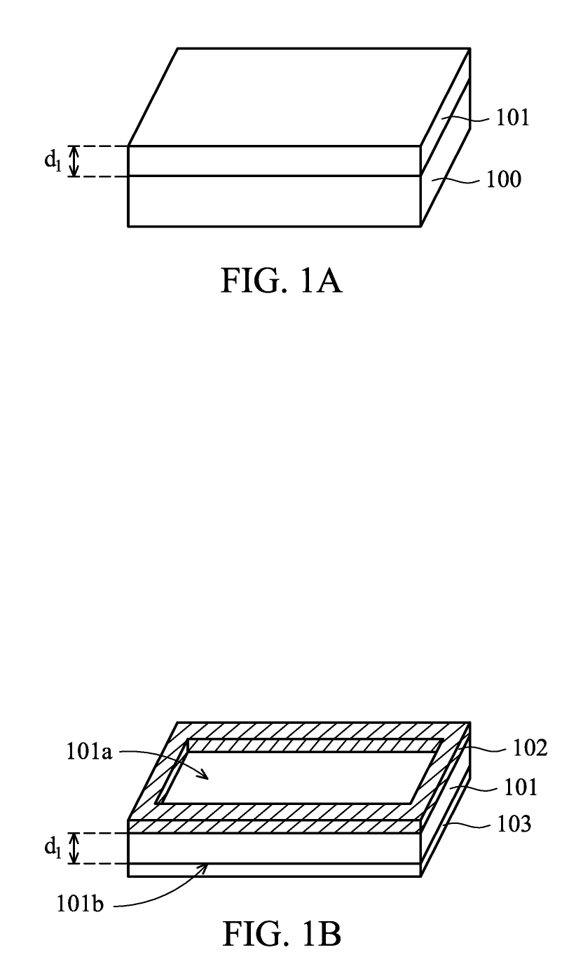

FIGS. 1A-1D shows perspective views of various stages of a method of fabricating a curved stack structure 300 according to some embodiments of the disclosure. Referring to FIG. 1A, a carrier 100 is provided, and a substrate 101 having a smaller thickness is attached to the carrier 100 having a greater thickness by a glass on glass (GOG) process or a roll to roll (R2R) process. The stack of the carrier 100 and the substrate 101 can undergo subsequent processes to avoid lack of rigidity and stiffness. Lack of rigidity and stiffness may cause difficulty in subsequent processes. In the embodiment, the carrier 100 may be alkali-free glass or alkali-containing glass. The substrate 101 may be alkali-free glass, alkali-containing glass or chemical-strengthening glass, and the thickness d₁ of the substrate 101 is greater than or equal to 0.01 mm and less than or equal to 0.4 mm. Thus, the substrate 101 can be called thin glass or ultra-thin glass. Since the thickness d₁ of the substrate 101 is less than or equal to 0.4 mm, the substrate 101 has bendability, flexibility or the ability to be foldable. In some embodiments, the thickness d₁ of the substrate 101 is greater than or equal to 0.03 mm and less than or equal to 0.4 mm. In some embodiments, the thickness d₁ of the substrate 101 is greater than or equal to 0.04 mm and less than or equal to 0.2 mm. In the embodiment, the carrier 100 is used for carrying the substrate 101, and the carrier 100 may be temporarily removed or permanently removed during or after subsequent processes. In some other embodiments, if the carrier 100 is used as a part of resulting stack structure, the carrier 100 may not be removed.

In some other embodiments, the material of the substrate 101 may be replaced by another non-glass material formed as single, mixed or stacked polymer material (polyimide (PI), plastic or rubber), metal or ceramic material, and transparent material is preferred, but the disclosure is not limited thereto. The material of the carrier 100 may be replaced by another non-glass material formed as single, mixed or stacked polymer material (polyimide, polymethylmethacrylate (PMMA), polycarbonate (PC), plastic or rubber), metal, ceramic material or composite material, and material that has similar material characteristics as the material of the substrate 101 is preferred, but the disclosure is not limited thereto. The glass on glass process used on the carrier 100 and the substrate 101 may be vacuum adsorption, electrostatic adsorption, gluing, or another process of physical or chemical bonding, but the disclosure is not limited thereto.

In some embodiments, when there is a requirement for the substrate 101 to be strengthened and the substrate 101 is glass that is capable of being chemically strengthened, the substrate 101 may be soaked in a chemical solution such as potassium nitrate to perform ion exchange and form a chemical-strengthening layer (not shown) on the surface of the substrate 101 before the substrate 101 and the carrier 100 are attached together. Then, the strengthened substrate 101 is attached to the carrier 100.

Referring to FIG. 1B, the substrate 101 has a first surface 101a and a second surface 101b opposite to the first surface 101a. The first surface 101a is a non-viewing surface facing away from a viewer after the substrate 101 is modularized. The second surface 101b is a viewing surface facing a viewer after the substrate 101 is modularized. In the embodiment, the second surface 101b of the substrate 101 is attached to the carrier 100. In the embodiment, a light-shielding layer 102 is disposed on a peripheral area of the first surface 101a of the substrate 101 by screen printing, inkjet printing or transfer printing, but the disclosure is not limited thereto. In the embodiment, the light-shielding layer 102 comprises a single layer, multiple layers or in a composite way of using photo-curable ink, thermal-curable ink, or another light-shielding material, but the disclosure is not limited thereto. The color of the light-shielding layer 102 comprises any color that does not make light transmission easy, such as white, black, grey, red, green, blue, gold, silver, another suitable color, or a combination thereof, but the disclosure is not limited thereto. The light-shielding layer 102 is used to decorate the color of an exterior frame of the curved stack structure 300 shown in FIG. 1D.

Then, the carrier 100 is removed, and a functional layer 103 is disposed on the second surface 101b of the substrate 101 by a deposition process (for example, a physical vapor deposition process, a chemical vapor deposition process or another suitable process), a printing process or a spraying process, but the disclosure is not limited thereto. In the embodiment, the light-shielding layer 102 and the functional layer 103 are disposed on opposite sides of the substrate 101. The substrate 101 is located between the light-shielding layer 102 and the functional layer 103. In some other embodiments, the carrier 100 may be removed or be kept, and the functional layer 103 is disposed on the light-shielding layer 102. Namely, the functional layer 103 is also on the first surface 101a of the substrate 101, and the light-shielding layer 102 is located between the substrate 101 and the functional layer 103. In some embodiments, the functional layer 103 may include an anti-scratch layer, an anti-glare layer, an anti-reflection layer, an anti-smudge layer, or a combination thereof, but the disclosure is not limited thereto. After the functional layer 103 is formed, the carrier 100 may be removed, and the substrate 101 and the related light-shielding layer 102 and the functional layer 103 are cut to the desired shape by a laser, a wheel, or another suitable cutting method, but the disclosure is not limited thereto. The profile of the substrate 101 after cutting may be a rectangle or a non-rectangular type such as a circle, oval, triangle, hexagon, octagon or another irregular shape, but the disclosure is not limited thereto. Since the light-shielding layer 102 is designed by the cutting pattern and the path of cutting may be located at an edge near the outer side of the light-shielding layer 102, the light-shielding layer 102 would still cover the peripheral area of the substrate 101. The peripheral area is located outside and adjacent to a light-transmitting area in the substrate 101.

Referring to FIG. 1C, an adhesive layer 104 is attached on the first surface 101a of the substrate 101. The adhesive layer 104 is in contact with the substrate 101 in the light-transmitting area and the light-shielding layer 102 in the peripheral area. The light-shielding layer 102 is located between the substrate 101 and the adhesive layer 104. The adhesive layer 104 has a thickness d₂. In the embodiment, the thickness d₂ of the adhesive layer 104 may be between 50 μm and 1000 μm. In some other embodiments, the thickness d₂ may be between 100 μm and 800 μm. In the embodiment, the area of the adhesive layer 104 may be greater than or equal to the area of the substrate 101, and the boundary profile of the substrate 101 may be located within the boundary profile of the adhesive layer 104. In some other embodiments, the area of the adhesive layer 104 may be less than or equal to the area of the substrate 101, and the boundary profile of the adhesive layer 104 may be located within the boundary profile of the substrate 101. In the embodiment, the material of the adhesive layer 104 may include optical clear adhesive (OCA), optical clear resin (OCR) or another suitable transparent and adhesive material, but the disclosure is not limited thereto.

Then, a base (or spine) 105 is provided. The area of the base 105 may be greater than or equal to the area of the adhesive layer 104, and the boundary profile of the adhesive layer 104 may be located within the boundary profile of the base 105. The base 105 at least has a curved surface. The curved surface may be formed in a single or multiple staggered way of convex part, convex point, concave part or concave point. The exterior of the curved surface may be seen as a υ shape, ω shape, Ω shape, ν shape, σ shape or o shape in a cross section. There is a height difference Z. There is a highest point in the partial area such as a ridge point or a top point and a lowest point in the partial area such as a saddle point or a concave point, and there is a single vertical distance between a tangent plane of the highest point in the partial area and a tangent plane of the lowest point in the partial area. This distance is called the height difference or the surface height difference. The distance is the largest value of the height difference in the partial area and is disposed in a partial area of the curved surface, and may be greater than or equal to 2 cm and less than or equal to 20 cm. In some embodiments, the height difference Z may be greater than or equal to 4 cm and less than or equal to 18 cm. In some embodiments, the height difference Z may be greater than or equal to 5 cm and less than or equal to 16 cm. The base 105 has a thickness d₃. The thickness d₃ is greater than or equal to the thickness d₂. The thickness d₃ is greater than the thickness d₁. In some embodiments, the thickness d₃ is greater than or equal to 1 mm and less than or equal to 10 mm. The thickness d₃ is greater than the thickness d₁. In some embodiments, the thickness d₃ is greater than or equal to 1 mm and less than or equal to 5 mm. In some embodiments, the thickness d₃ is greater than or equal to 1 mm and less than or equal to 3 mm. The profile of the base 105 may be a rectangle or another non-rectangular shape such as a circle, oval, triangle, hexagon or another irregular shape, but the disclosure is not limited thereto. In some embodiments, the material of the base 105 may include glass, polymethylmethacrylate (PMMA), polycarbonate (PC) or another suitable material, but the disclosure is not limited thereto.

Then, a stack structure formed by the functional layer 103, the substrate 101, the light-shielding layer 102 and the adhesive layer 104 is conformably attached to curved surface of the base 105 using a laminating process 110 to finish the curved stack structure 300 shown in FIG. 1D. As shown in FIG. 1D, the substrate 101 is disposed between the functional layer 103 and the base 105. In some other embodiments, the laminating process 110 may also be replaced by vacuum adsorption, electrostatic adsorption or another attaching process. In some embodiments, the shape of the curved stack structure 300 is similar to the shape of the curved surface of the base 105. The curved stack structure 300 may include a plurality of continuous or discontinuous concave surfaces and convex surfaces, but the disclosure is not limited thereto.

In some embodiments, the edges of all layers of the curved stack structure 300 are adjusted so that they are aligned with one another. In a cross section, when the radius (R) of curvature of the substrate 101 of the curved stack structure 300 in an area is longer than the radius (R) of curvature of the adhesive layer 104 in the area, and the radius (R) of curvature of the adhesive layer 104 in the area is longer than the radius (R) of curvature of the base 105 in the area, the length of the substrate 101 along the direction of the cross section in the area is greater than 100.1% of the length of the adhesive layer 104 along the direction of the cross section in the area, and the length of the adhesive layer 104 along the direction of the cross section in the area is greater than 100.1% of the length of the base 105 along the direction of the cross section in the area. In some embodiments, the length of the substrate 101 along the direction of the cross section in the area is 100%-100.2% of the length of the adhesive layer 104 along the direction of the cross section in the area, and the length of the adhesive layer 104 along the direction of the cross section in the area is 100%-100.2% of the length of the base 105 along the direction of the cross section in the area. In some other embodiments, the length of the substrate 101 along the direction of the cross section in the area is 100%-101% of the length of the adhesive layer 104 along the direction of the cross section in the area, and the length of the adhesive layer 104 along the direction of the cross section in the area is 100%-101% of the length of the base 105 along the direction of the cross section in the area.

In some other embodiments, the edges of all layers of the curved stack structure 300 are adjusted so that they are aligned with one another. In a cross section, when the radius (R) of curvature of the base 105 of the curved stack structure 300 in an area is longer than the radius (R) of curvature of the adhesive layer 104 in the area, and the radius (R) of curvature of the adhesive layer 104 in the area is longer than the radius (R) of curvature of the substrate 101 in the area, the length of the base 105 along the direction of the cross section in the area is greater than 100.1% of the length of the adhesive layer 104 along the direction of the cross section in the area, and the length of the adhesive layer 104 along the direction of the cross section in the area is greater than 100.1% of the length of the substrate 101 along the direction of the cross section in the area. In some embodiments, the length of the base 105 along the direction of the cross section in the area is 100%-100.2% of the length of the adhesive layer 104 along the direction of the cross section in the area, and the length of the adhesive layer 104 along the direction of the cross section in the area is 100%-100.2% of the length of the substrate 101 along the direction of the cross section in the area. In some other embodiments, the length of the base 105 along the direction of the cross section in the area is 100%-101% of the length of the adhesive layer 104 along the direction of the cross section in the area, and the length of the adhesive layer 104 along the direction of the cross section in the area is 100%-101% of the length of the substrate 101 along the direction of the cross section in the area.

In the embodiment, the above-mentioned printing process, deposition process, cutting process and the process of the adhesive layer 104 attached to the light-shielding layer 102 and the substrate 100 are all plane processes, which can be completed in a two-dimensional plane. The above-mentioned laminating process 110 is a curved surface process, which can be completed in three-dimensional (3D) space.

In the curved stack structure 300 finished in the above-mentioned laminating process 110, the light-shielding layer 102 is disposed on the surface (i.e. first surface 101a) of the substrate 101 close to the base 105 on the peripheral area. Namely, the light-shielding layer 102 is located between the substrate 101 and the adhesive layer 104. The functional layer 103 is disposed on the surface (i.e. the second surface 101b) of the substrate 101 away from the base 105. Namely, the functional layer 103 is located on the viewing surface.

Since the substrate 101 is an ultra-thin glass having a thickness d₁ less than or equal to 0.4 mm, the substrate 101 has flexibility. Under the condition that the substrate 101 has flexibility, the substrate 101 can be conformably attached to the curved surface of the base 105 without using a heating process for 3D forming to finish the curved stack structure 300, but the disclosure is not limited thereto. The heating process can also be used. In addition, since the curved stack structure 300 is finished without performing a heating process for 3D forming on the substrate 101, the substrate 101 of the curved stack structure 300 can overcome restrictions in equipments for processing curved surface objects (then the height difference Z can be greater than 5 cm), and the substrate 101 can obtain a more uniform surface processing effect. Moreover, since the curved stack structure 300 is finished without a heating process for 3D forming being performed on the substrate 101, the chosen processing material (such as ink) processing on the substrate 101 of the curved stack structure 300 is less restricted by the temperature, and the light-shielding layer 102 on the substrate 101 can have a better shielding effect.

Moreover, since the curved stack structure 300 is a glued laminated structure which laminates the substrate 101, the adhesive layer 104 and the base 105 together, and the materials of the substrate 101 and the base 105 are glass, the glued laminated structure can be called laminated safety glass (LSG). Therefore, the curved stack structure 300 has better structural strength and can pass a hit impact test (HIT). The curved stack structure 300 can be used as a component in aerospace transportation, cars, boats, or another form of transportation.

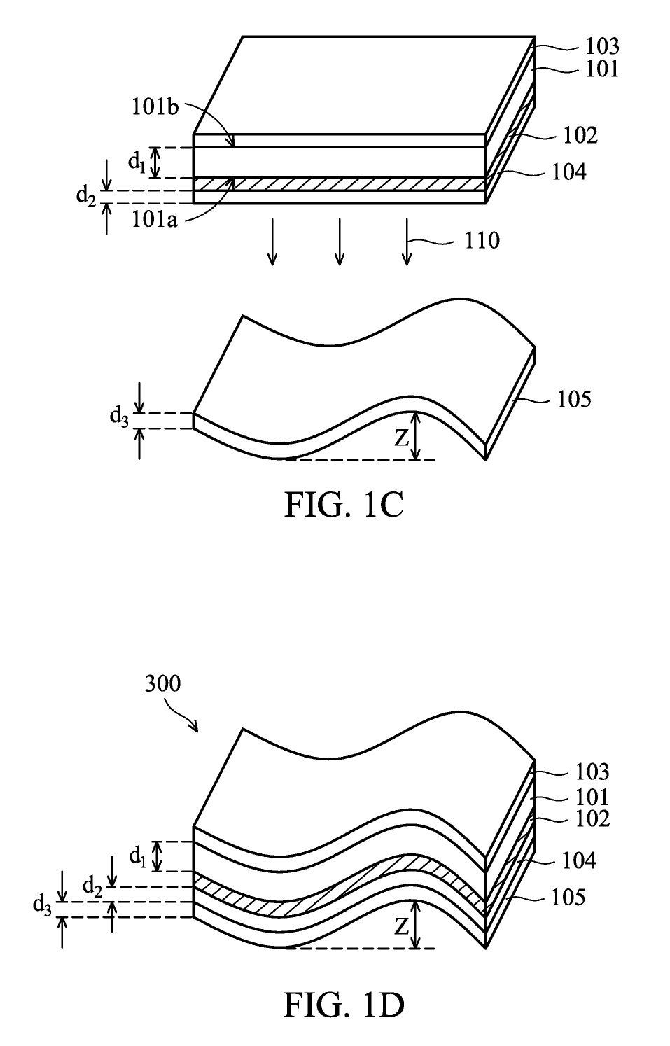

Referring to FIGS. 2A-2D, they show perspective views of various stages of a method of fabricating a curved stack structure 400 according to some other embodiments of the disclosure. Elements in FIGS. 2A-2D that are the same as those in FIGS. 1A-1D are labeled with the same reference numbers as in FIGS. 1A-1D and are not described again for brevity.

The method for fabricating the curved stack structure 400 shown in FIGS. 2A-2D is similar to that of the method for fabricating the curved stack structure 300 shown in FIGS. 1A-1D. The difference between the curved stack structure 400 and the curved stack structure 300 is in the embodiment of FIG. 2C, an adhesive layer 201 is conformably disposed on the curved surface of the base 105, and the adhesive layer 201 has a thickness d₄. Then, an entire structure of the functional layer 103, the substrate 101 and the light-shielding layer 102 is conformably attached to the adhesive layer 201 by a laminating process 210 to finish the curved stack structure 400 shown in FIG. 2D. In some embodiments, the laminating process 210 is performed in a vacuum chamber under high temperature and high pressure. In the embodiment, the material of the adhesive layer 201 may include polyvinylbutyral (PVB) or another suitable transparent and adhesive material, and the thickness d₄ is between 100 μm and 800 μm. In some other embodiments, the thickness d₄ is between 50 μm and 1000 μm.

In the embodiment, the high temperature of the laminating process 210 makes the polyvinylbutyral become adhesive, and the substrate 101, the adhesive layer 201 and the base 105 can have a better bonding force to be bonded together. The polyvinylbutyral is highly light-transmitting, and a highly light-transmitting laminated safety glass is thereby obtained. The curved stack structure 400 would have better structural strength and optical performance, and it can pass a hit impact test and meet the requirements of optical transparency.

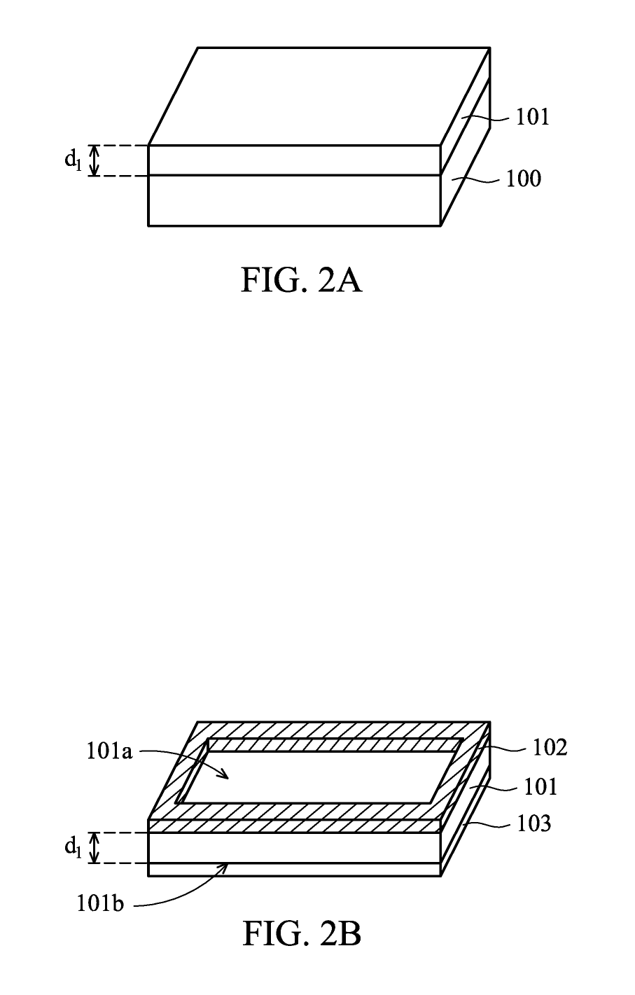

Referring to FIGS. 3A-3D, they show perspective views of various stages of a method for fabricating a curved touch panel 600 according to some embodiments of the disclosure. Elements in FIGS. 3A-3D that are the same as those in FIGS. 1A-1D are labeled with the same reference numbers as in FIGS. 1A-1D and are not described again for brevity.

The method for fabricating the curved touch panel 600 shown in FIGS. 3A-3D is similar to that of the method of fabricating the curved stack structure 300 shown in FIGS. 1A-1D. The difference between the curved stack structure 600 and the curved stack structure 300 is in the embodiment of FIG. 3B, a patterned touch-sensing electrode layer 301 and black matrix layer 302 are disposed on the first surface 101a of the substrate 101 by a deposition process (for example, a physical vapor deposition process, a chemical vapor deposition process or another suitable process) and a photolithography process. The touch-sensing electrode layer 301 is located in a touch area 10, and the touch area 10 corresponds to the light-transmitting area of the substrate 101. The black matrix layer 302 is located in peripheral area 20 near the touch-sensing electrode layer 301. Then, the functional layer 103 is disposed on the second surface 101b of the substrate 101 by a deposition process (for example, a physical vapor deposition process, a chemical vapor deposition process or another suitable process). After the functional layer 103 is formed, the substrate 101 is cut to the desired shape by a laser, a wheel, or another suitable cutting method. In some embodiments, the material of the touch-sensing electrode layer 301 may include transparent conductive material such as indium tin oxide (ITO), indium zinc oxide (IZO), fluorine doped tin oxide (FTO), aluminum doped zinc oxide (AZO), gallium doped zinc oxide (GZO) or another suitable transparent conductive material. In some embodiments, the material of the touch-sensing electrode layer 301 may be metal, another transparent conductive material or another non-transparent conductive material, such as metal mesh, carbon nano-tube (CNT), silver nano-wire or grapheme. In some embodiments, the material of the black matrix layer 302 may be metal, organic material or ink, such as Cr or black resin. In some embodiments, the black matrix layer 302 can be any color that does not easily transmit light and has a certain thickness to decrease the transmittance, and conductive lines (not shown) connected to the touch-sensing electrode layer 301 in the peripheral area 20 can be shielded. In some other embodiments, the touch-sensing electrode layer 301 may be disposed between the substrate 101 and the functional layer 103.

Referring to FIG. 3C, the adhesive layer 104 is attached to the touch-sensing electrode layer 301, the black matrix layer 302 and the first surface 101a of the substrate 100, and the adhesive layer 104 has a thickness d₂. Then, the base 105 is provided. The base 105 has a curved surface, and the height difference Z of the curved surface can be greater than 5 cm, but the disclosure is not limited thereto. The base 105 has a thickness d₃. Then, an entire structure of the functional layer 103, the substrate 101, the touch-sensing electrode layer 301, the black matrix layer 302 and the adhesive layer 104 is conformably attached to the base 105 using a laminating process 110 to finish the curved touch panel 600 shown in FIG. 3D. In the embodiment, the material of the adhesive layer 104 may include optical clear adhesive (OCA), optical clear resin (OCR) or another suitable transparent and adhesive material, and the thickness d₂ is between 100 μm and 800 μm. In some embodiments, the material of the base 105 may include glass, polymethylmethacrylate (PMMA), polycarbonate (PC) or another suitable material. The height difference Z is between 5 cm and 16 cm, and the thickness d₃ is between 1 mm and 3 mm. In some other embodiments, the height difference Z may be between 2 cm and 20 cm, and the thickness d₂ may be between 50 μm and 1000 μm, and the thickness d₃ is between 1 mm and 10 mm.

In the embodiment, the above-mentioned printing process, deposition process, cutting process and the process of the adhesive layer 104 attached to the touch-sensing electrode layer 301, the black matrix layer 302 and the substrate 100 are all plane processes completed in a two-dimensional plane. The above-mentioned laminating process 110 is a curved surface process completed in three-dimensional (3D) space.

In the curved touch panel 600, the touch-sensing electrode layer 301 and the black matrix layer 302 are disposed on the surface (i.e. first surface 101a) of the substrate 101 close to the base 105. Namely, the touch-sensing electrode layer 301 and the black matrix layer 302 are located between the substrate 101 and the adhesive layer 104 and between the substrate 101 and the base 105. The functional layer 103 is disposed on the surface (i.e. the second surface 101b) of the substrate 101 away from the base 105. Namely, the functional layer 103 is located on the viewing surface.

Since the touch-sensing electrode layer 301 is disposed on the substrate 101 of the curved touch panel 600, the curved touch panel 600 is a one-glass touch panel, or a so-called window integrated sensor (WIS). The curved touch panel 600 can have the advantages of a one-glass touch panel (such as a lighter and thinner structure) and the advantages of the above-mentioned curved stack structure 300 of FIG. 1D.

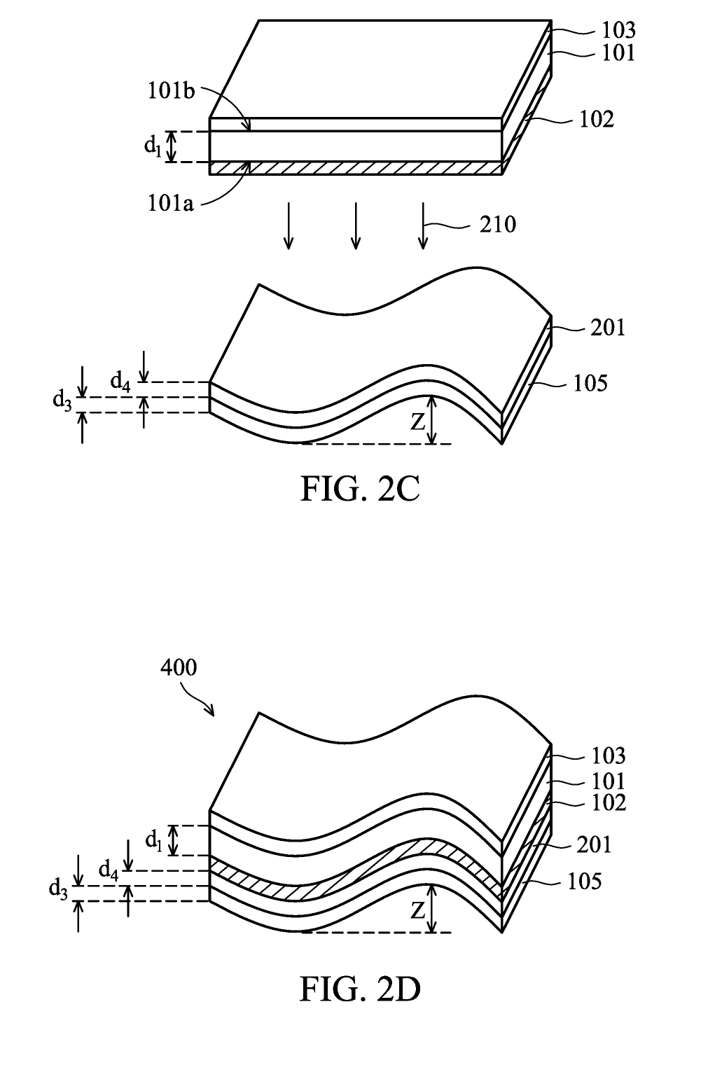

Referring to FIGS. 4A-4D, they show perspective views of various stages of a method for fabricating a curved touch panel 700 according to some other embodiments of the disclosure. Elements in FIGS. 4A-4D that are the same as those in FIGS. 3A-3D are labeled with the same reference numbers as in FIGS. 3A-3D and are not described again for brevity.

The method for fabricating the curved touch panel 700 shown in FIGS. 4A-4D is similar to that of the method for fabricating the curved touch panel 600 shown in FIGS. 3A-3D. The difference between the curved stack structure 700 and the curved stack structure 600 is in the embodiment of FIG. 4C, the adhesive layer 201 is conformably disposed on the curved surface of the base 105, and the adhesive layer 201 has a thickness d₄. Then, the entire structure of the functional layer 103, the substrate 101, the touch-sensing electrode layer 301 and the black matrix layer 302 is attached to the adhesive layer 201 using a laminating process 110 to finish the curved touch panel 700 shown in FIG. 4D. In some embodiments, the laminating process 110 is performed in a vacuum chamber under high temperature and high pressure. In the embodiment, the material of the adhesive layer 201 may include polyvinylbutyral (PVB) or another suitable transparent and adhesive material, and the thickness d₄ is between 100 μm and 800 μm.

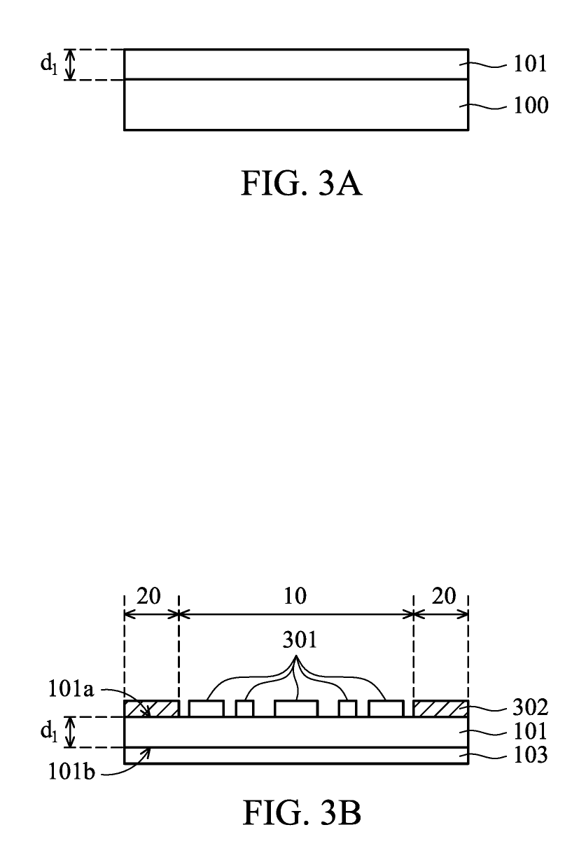

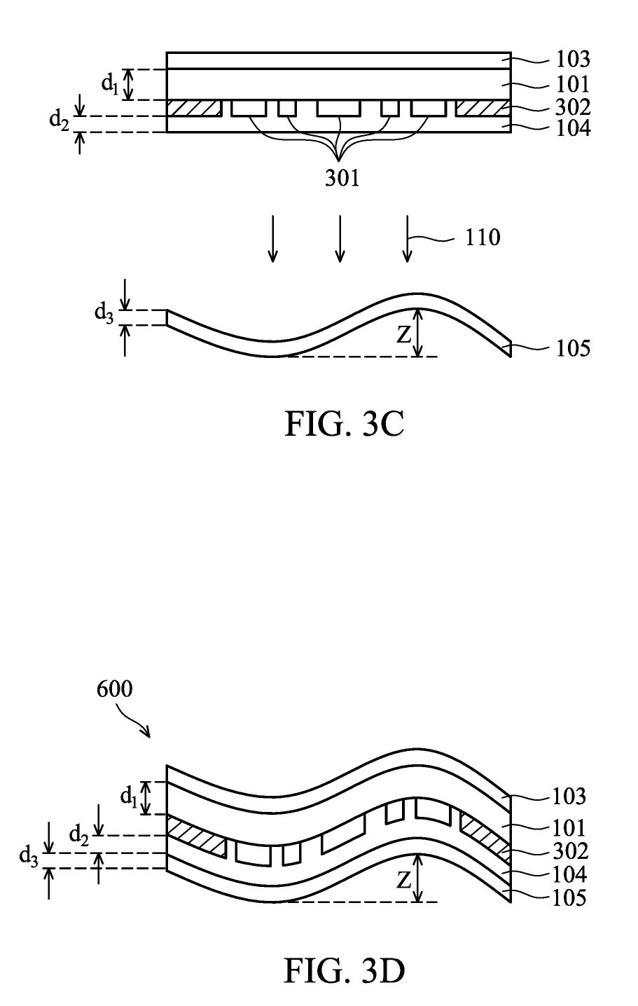

Referring to FIG. 5A, it shows a cross section of a curved electronic device 800 according to some embodiments of the disclosure. The curved electronic device 800 includes the curved stack structure 300 and a display panel 502 conformably disposed under the substrate 101 (not shown in FIG. 5A) of the curved stack structure 300. In the embodiment, the display panel 502 is located on the base 105 of the curved stack structure 300 shown in FIG. 1D. Namely, the base 105 of the curved stack structure 300 shown in FIG. 1D is located between the display panel 502 and the substrate 101 of the curved stack structure 300 shown in FIG. 1D. The display panel 502 is located on the base 105 and over the first surface 101a, and the curved stack structure 300 is located between the viewer and the display panel 502. In some embodiments, the display panel 502 may be a liquid-crystal display (LCD), a light-emitting diode display, an organic light-emitting diode (OLED) display, an electrophoresis display, an electrowetting display or another self-luminous or non-self-luminous display. It is not necessary for the self-luminous display to have a backlight module, and a backlight module is required to be disposed on the backside of the display panel 502 (opposite side to the curved stack structure 300). The material of the substrate of the display panel 502 may be glass, quartz, plastic, rubber, metal foil or another inorganic or organic polymer material, but the disclosure is not limited thereto. The above-mentioned curved electronic device 800 may be a mobile phone, digital camera, personal digital assistant (PDA), laptop, desktop computer, television, car display, or portable DVD player.

In the embodiment, the curved electronic device 800 further includes a touch structure 501 disposed between the base 105 (not shown in FIG. 5A) of the curved stack structure 300 and the display panel 502. In some other embodiments, the curved stack structure 300 is disposed between the touch structure 501 and the display panel 502. In some other embodiments, the display panel 502 is disposed between the curved stack structure 300 and the touch structure 501. In some other embodiments, the curved electronic device 800 may not include the touch structure 501.

Referring to FIG. 5B, it shows a cross section of a curved electronic device 900 according to some other embodiments of the disclosure. Elements in FIG. 5B that are the same as those in FIG. 5A are labeled with the same reference numbers as in FIG. 5A and are not described again for brevity.

The curved electronic device 900 shown in FIG. 5B is similar to that of the curved electronic device 800 shown in FIG. 5A. The difference between the curved electronic device 900 and the curved electronic device 800 is in the embodiment of FIG. 5B, the base 105 of the curved stack structure 300 is disposed between the touch structure 501 and the display panel 502. The touch structure 501 can be adjacent to the substrate of the display panel 502 or adjacent to the base 105 of the curved stack structure 300. In some other embodiments, the curved electronic device 900 may not include the touch structure 501. In some other embodiments, the substrate of the display panel 502 has a touch structure 501 thereon, and the touch structure 501 is one of the elements that are disposed on the substrate of the display panel 502.

In some other embodiments, the stack order of the curved electronic device 900 is the functional layer 103→the touch structure 501→the substrate 101→the light-shielding layer 102→the adhesive layer 104→the base 105→the display panel 502. In some other embodiments, the stack order of the curved electronic device 900 is the touch structure 501→the functional layer 103→the substrate 101→the light-shielding layer 102→the adhesive layer 104→the base 105→the display panel 502. In some other embodiments, the stack order of the curved electronic device 900 is the display panel 502→the functional layer 103→the substrate 101→the light-shielding layer 102→the adhesive layer 104→the touch structure 501→the base 105. In some other embodiments, the stack order of the curved electronic device 900 is the display panel 502→the functional layer 103→the touch structure 501→the substrate 101→the light-shielding layer 102→the adhesive layer 104→the base 105. In some other embodiments, the stack order of the curved electronic device 900 is the display panel 502→the touch structure→the functional layer 103→the substrate 101→the light-shielding layer 102→the adhesive layer 104→the base 105. In some other embodiments, the stack order of the curved electronic device 900 is the touch structure 501→the display panel 502→the functional layer 103→the substrate 101→the light-shielding layer 102→the adhesive layer 104→the base 105.

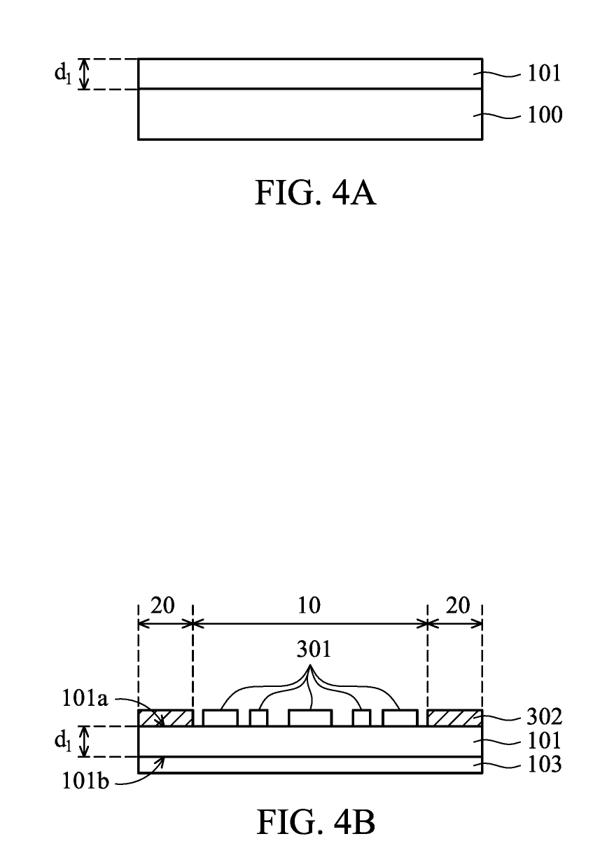

Referring to FIG. 6, it shows a cross section of a curved electronic device 1000 according to some other embodiments of the disclosure. Elements in FIG. 6 that are the same as those in FIG. 5A are labeled with the same reference numbers as in FIG. 5A and are not described again for brevity.

The curved electronic device 1000 shown in FIG. 6 is similar to that of the curved electronic device 800 shown in FIG. 5A. The difference between the curved electronic device 1000 and the curved electronic device 800 is in the embodiment of FIG. 6, the curved stack structure 300 is replaced by the curved stack structure 400.

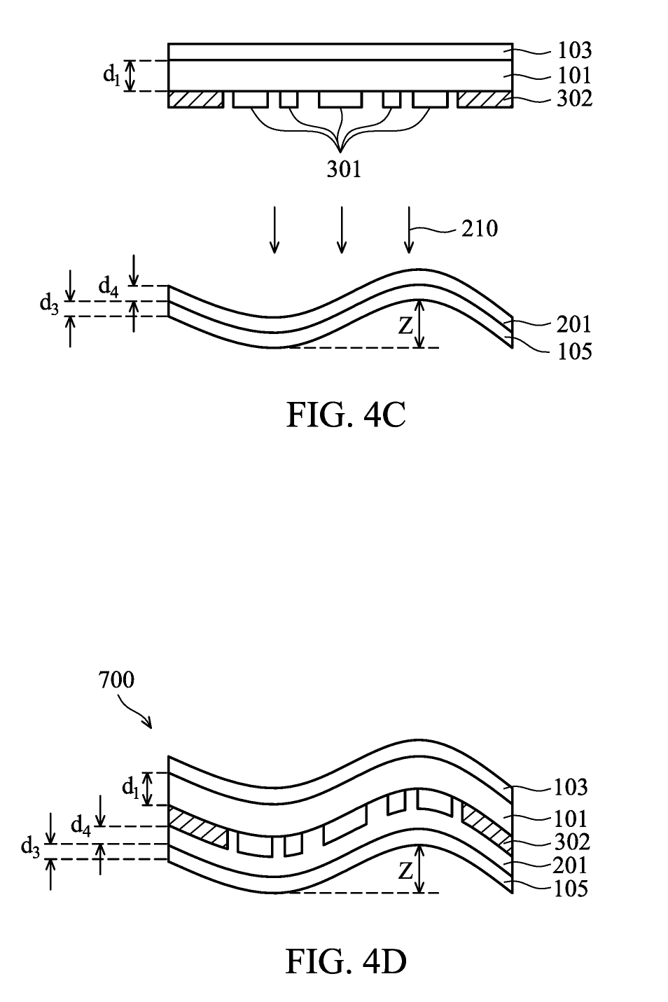

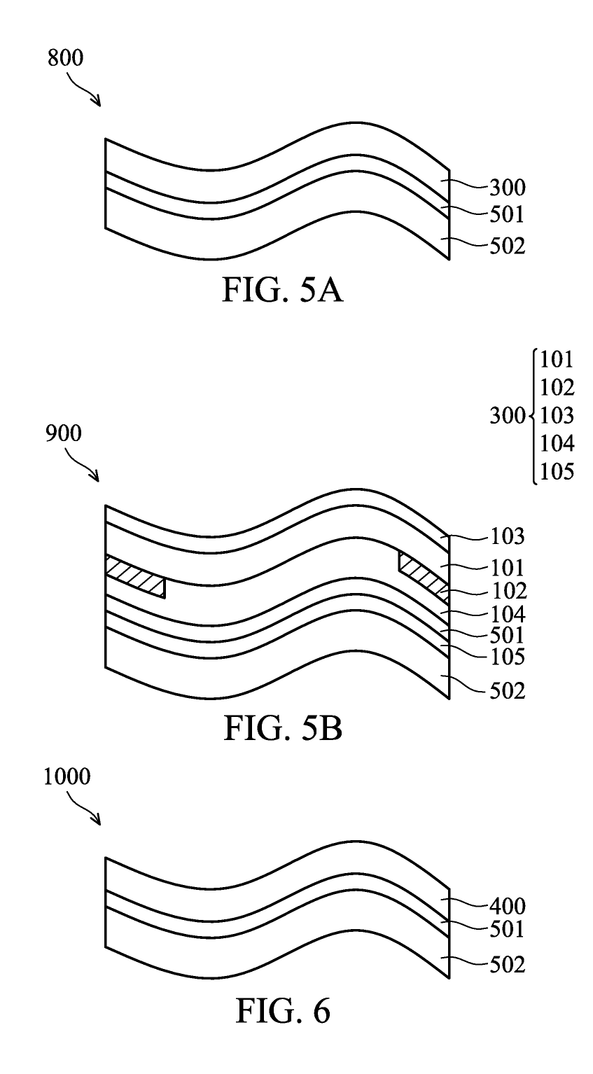

Referring to FIG. 7, it shows a cross section of a curved electronic device 1100 according to some embodiments of the disclosure. The curved electronic device 1100 includes the curved touch panel 600 and the display panel 502 conformably disposed under the substrate 101 (not shown in FIG. 7A) of the curved surface of the curved touch panel 600. As shown in FIG. 3D, in addition to the curved touch panel 600 including all structures of the curved stack structure 300, the curved touch panel 600 further includes the touch-sensing electrode layer 301 located on the surface of the substrate 101 near the base 105. In the embodiment, the display panel 502 is located under the base 105 (not shown in FIG. 7A) of the curved touch panel 600. The display panel 502 is disposed on the base 105 and over the first surface 101a.

Referring to FIG. 7B, it shows a cross section of a curved electronic device 1200 according to some other embodiments of the disclosure. Elements in FIG. 7B that are the same as those in FIG. 7A are labeled with the same reference numbers as in FIG. 7A and are not described again for brevity.

The curved electronic device 1200 shown in FIG. 7B is similar to that of the curved electronic device 1100 shown in FIG. 7A. The difference between the curved electronic device 1200 and the curved electronic device 1100 is in the embodiment of FIG. 7B, the base 105 of the curved touch panel 600 is disposed between the adhesive layer 104 and the display panel 502.

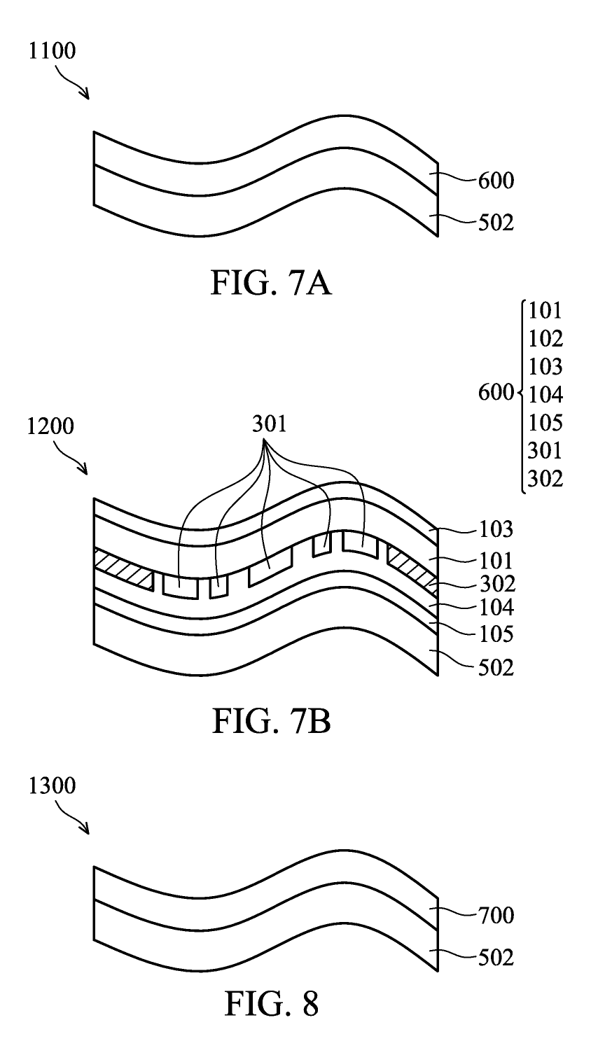

Referring to FIG. 8, it shows a cross section of a curved electronic device 1300 according to some other embodiments of the disclosure. Elements in FIG. 8 that are the same as those in FIG. 7A are labeled with the same reference numbers as in FIG. 7A and are not described again for brevity.

The curved electronic device 1300 shown in FIG. 8 is similar to that of the curved electronic device 1100 shown in FIG. 7A. The difference between the curved electronic 1300 and the curved electronic device 1100 is in the embodiment of FIG. 8, the curved touch panel 600 is replaced by the curved touch panel 700.

According to some embodiments of the disclosure, since the thickness of the substrate of the curved stack structure is less than or equal to 0.4 mm, the substrate 101 has flexibility. Provided that the substrate 101 has flexibility, the substrate can be conformably attached to the curved surface of the base without using a heating process for 3D forming to finish the curved stack structure.

Since the curved stack structure can be finished without performing a heating process for 3D forming on the substrate, the processes performed on the substrate are all plane processes. Compared to conventional processes of printing after bending, the substrate of the curved stack structure can overcome restrictions in equipments for processing objects having a curved surface (such as the vertical height of the curved surface needing to be less than 5 cm), and the substrate can also obtain a more uniform surface processing effect. In addition, since the curved stack structure is finished without performing a heating process for 3D forming on the substrate, the chosen processing material (such as ink) of the processing on the substrate of the curved stack structure is less restricted by the temperature compared to conventional processes of printing after bending, and the light-shielding layer on the substrate can have a better shielding effect.

Moreover, since the curved stack structure is a glued laminated structure which laminates the substrate, the adhesive layer and the base together, and the glued laminated structure can also be called laminated safety glass (LSG). In some embodiments, the substrate, the adhesive layer and the base can have a better bonding force to be bonded together by the laminating process under high temperature. Therefore, the curved stack structure has a better structural strength and can pass the hit impact test (HIT).

While the disclosure has been described by way of example and in terms of the embodiments, it is to be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A curved stack structure, comprising:
a base having a curved surface;
an adhesive layer disposed on the base; and
a substrate disposed on the adhesive layer, wherein the substrate has a first thickness that is greater than or equal to 0.01 mm and less than or equal to 0.4 mm.

2. The curved stack structure of claim 1, wherein a height difference of the curved surface is greater than or equal to 2 cm and less than or equal to 20 cm.

3. The curved stack structure of claim 2, wherein the height difference of the curved surface is greater than or equal to 4 cm and less than or equal to 18 cm.

4. The curved stack structure of claim 3, wherein the height difference of the curved surface is greater than or equal to 5 cm and less than or equal to 16 cm.

5. The curved stack structure of claim 1, wherein the substrate has a chemical-strengthening layer.

6. The curved stack structure of claim 1, further comprising:
a light-shielding layer disposed between the adhesive layer and the substrate and correspondingly disposed on a peripheral area of the substrate; and
a functional layer, wherein the substrate is disposed between the functional layer and the light-shielding layer.

7. The curved stack structure of claim 1, wherein in a first cross section, the substrate has a first length, the adhesive layer has a second length, and the base has a third length, and wherein the first length is 100%-101% of the second length, and the second length is 100%-101% of the third length.

8. The curved stack structure of claim 1, wherein in a first cross section, the substrate has a first length, the adhesive layer has a second length, and the base has a third length, and wherein the third length is 100%-101% of the second length, and the second length is 100%-101% of the first length.

9. A method for fabricating a curved stack structure, comprising:
providing a base having a curved surface;
fabricating an adhesive layer disposed on the base; and
providing a substrate and attaching the substrate to the adhesive layer, wherein the substrate has a first thickness that is greater than or equal to 0.01 mm and less than or equal to 0.4 mm.

10. The method of claim 9, wherein the height difference of the curved surface is greater than or equal to 2 cm and less than or equal to 20 cm.

11. The method of claim 10, wherein the height difference of the curved surface is greater than or equal to 4 cm and less than or equal to 18 cm.

12. The method of claim 11, wherein the height difference of the curved surface is greater than or equal to 5 cm and less than or equal to 16 cm.

13. The method of claim 9, further comprising performing a laminating process to closely laminate the base, the adhesive layer and the substrate together, and the laminating process is performed in a vacuum chamber under high temperature and high pressure.

14. The method of claim 9, further comprising:
fabricating a light-shielding layer between the adhesive layer and the substrate, and the light-shielding layer is correspondingly disposed on a peripheral area of the substrate; and
fabricating a functional layer, wherein the substrate is disposed between the functional layer and the light-shielding layer.

15. A curved electronic device, comprising:
a curved stack structure, comprising:
a base having a curved surface;
an adhesive layer disposed on the base; and
a substrate disposed over the adhesive layer; and
a display panel disposed at a side of the curved stack structure,
wherein the substrate has a first thickness that is greater than or equal to 0.01 mm and less than or equal to 0.4 mm.

16. The curved electronic device of claim 15, further comprising a touch structure disposed between the curved stack structure and the display panel.

17. The curved electronic device of claim 15, further comprising a touch-sensing electrode layer disposed between the substrate and the base.

18. The curved electronic device of claim 15, further comprising a touch-sensing electrode layer disposed between the adhesive layer and the substrate.

19. The curved electronic device of claim 15, wherein the base is located between the display panel and the substrate.

20. The curved electronic device of claim 15, wherein the height difference of the curved surface is greater than or equal to 2 cm and less than or equal to 20 cm.
